(19) United States
(12) Patent Application Publication
(10) Pub. No.: US 2016/0337322 A1
(43) Pub. Date: Nov. 17, 2016

(54) SEMICONDUCTOR DEVICE FOR MANAGING USER DATA ACCORDING TO SECURITY LEVEL AND METHOD OF OPERATING THE SAME

(71) Applicant: SAMSUNG ELECTRONICS CO., LTD., SUWON-SI (KR)

(72) Inventors: BO GYEONG KANG, SEOUL (KR); MYUNG KOO KANG, SEOUL (KR); BYUNG SE SO, SEOUL (KR); DAE HWAN KIM, YONGIN-SI (KR); JAE WOO JUNG, CHEONAN-SI (KR); HYUN WOO CHUNG, YONGIN-SI (KR); SANG HWA JIN, SEONGNAM-SI (KR)

(21) Appl. No.: 15/151,994

(22) Filed: May 11, 2016

Related U.S. Application Data
(60) Provisional application No. 62/160,285, filed on May 12, 2015.
(60) Provisional application No. 62/215,397, filed on Sep. 8, 2015.

(30) Foreign Application Priority Data
Sep. 9, 2015 (KR) 10-2015-0127724

(51) Int. Cl. H04L 29/06; H04L 12/24; H04L 29/08

(52) U.S. Cl. CPC H04L 63/0428; H04L 67/12; H04L 41/12; H04L 63/08

(57) ABSTRACT

A method of operating a hub which manages user data communicated between a server and a plurality of internet of things (IoT) devices includes storing a user data management rule set by a user, processing sensitive data among user data transmitted from one of the IoT devices according to the user data management rule to generate processed data, and transmitting the processed data to the server.

### CROSS-REFERENCE TO RELATED APPLICATIONS

This application claims priority under 35 U.S.C. §119(e) to U.S. provisional patent application No. 62/160,285 filed on May 12, 2015, and 62/215,397 filed on Sep. 8, 2015 and under 35 U.S.C. §119(a) to Korean Patent Application No. 10-2015-0127724 filed on Sep. 9, 2015, the entire disclosure of each are incorporated by reference herein.

### BACKGROUND

1. Technical Field

Embodiments of the inventive concept relate to a semiconductor device, and more particularly, to a semiconductor device for efficiently managing and storing user data according to a security level or sensitivity and a method of operating the same.

2. Discussion of Related Art

An internet of things (IoT) is a network of physical objects (“things) embedded with electronics, software, sensors, and network connectivity (e.g., connectivity to the Internet), which enables these objects to collect and exchange data. As an example, the things can be embedded systems such as home appliances, mobile devices and wearable devices. A thing of the IoT (e.g., an IoT device) may have a unique Internet Protocol (IP) address to identify itself when it is connected to the Internet and includes a sensor to obtain data from an external environment.

Sensitive data such as a user's biometric information or health information may be transmitted by an IoT device. However, since the level of security and authentication is different among IoT devices, it can be difficult to ensure the security of this sensitive data.

### SUMMARY

According to an exemplary embodiment of the inventive concept, there is provided a method of operating a hub which manages user data communicated between a server and a plurality of internet of things (IoT) devices. The method includes storing, by the hub, a user data management rule set by a user; processing, by the hub, sensitive data among user data transmitted from one of the IoT devices according to the user data management rule to generate processed data; and transmitting, by the hub, the processed data to the server.

The method may further include storing the sensitive data that has not been processed in a memory of the hub.

The storing the user data management rule may include storing a basic data management rule, displaying the basic data management rule for the user to enable the user to request a change to the basic data management rule, and storing a changed data management rule according to the change request.

The method may further include authenticating the user using user authentication information; and allowing the user data management rule to be set, changed, or cancelled when the authenticating of the user is successful.

The data management rule may include at least one among a type of the sensitive data and a security level of the sensitive data.

The processing may include one of encrypting all of the sensitive data so that all the sensitive data is undistinguishable in the server and performing a blurring process on part of the sensitive data to that part of the sensitive data is undistinguishable in the server.

According to an exemplary embodiment of the inventive concept, there is provided a semiconductor device for managing user data communicated between a server and a plurality of IoT devices. The semiconductor device includes a first communication module configured to receive user data from one of the IoT devices, a data balancing module configured to process sensitive data among the user data according to a user data management rule set by a user to generate processed data, and a second communication module configured to transmit the processed data from the data balancing module to the server, where the semiconductor device enables the user data management rule to be set or changed by the user.

The semiconductor device may further include a memory configured to store the sensitive data that has not been processed.

The data balancing module may generate the processed data by processing a part or all of the sensitive data to be undistinguishable.

The data balancing module may compute trend information by performing an arithmetic operation on at least two data sets of the sensitive data, selecting the at least two data sets, or comparing the at least two data sets with each other and may output the trend information as the processed data.

The semiconductor device may further include a processor configured to authenticate the user using authentication information of the user and to allow the user data management rule to be changed or cancelled when the authentication of the user is successful.

The semiconductor device may be a hub.

According to an exemplary embodiment of the inventive concept, there is provided a semiconductor device for managing user data communicated between a server and a plurality of IoT devices. The semiconductor device includes a transceiver configured to receive the user data from one of the IoT devices and transmit processed data to the server, and a data processing circuit configured to perform a selected one of an encryption of all sensitive data among the user data or a blurring of part of the sensitive data to generate the processed data.

The semiconductor device may provide a user interface that enables a user to increase a security level to select the encryption and decrease the security level to select the blurring.

The semiconductor device may select one of the encrypting and blurring according to a user data management rule stored within the device. In an embodiment, the semiconductor device is configured to authenticate a user associated with the user data using authentication information stored within the device, and enables the rule to be changed by a user when the authentication is successful.

### BRIEF DESCRIPTION OF THE DRAWINGS

The inventive concept will become more apparent by describing in detail exemplary embodiments thereof with reference to the attached drawings in which:

FIG. 1 is a block diagram of a data processing system according to an exemplary embodiment of the inventive concept;

FIG. 2 is a block diagram of a data balancing module illustrated in FIG. 1 according to an exemplary embodiment of the inventive concept;

FIGS. 3A through 3C are diagrams for explaining a user data management rule according to an exemplary embodiment of the inventive concept;

FIG. 4A is a diagram for explaining the encryption of sensitive data;

FIG. 4B is a diagram for explaining the blurring of sensitive data;

FIG. 5 is a block diagram of a server illustrated in FIG. 1 according to an exemplary embodiment of the inventive concept;

FIG. 6 is a schematic flowchart of a method of operating a hub according to an exemplary embodiment of the inventive concept;

FIG. 7 is a detailed flowchart of the method of operating the hub according to an exemplary embodiment of the inventive concept;

FIG. 8 is a block diagram of a data processing system including the hub illustrated in FIG. 1 according to an exemplary embodiment of the inventive concept;

FIG. 9 is a block diagram of a data processing system including the hub illustrated in FIG. 1 according to an exemplary embodiment of the inventive concept;

FIG. 10 is a block diagram of a data processing system including the hub illustrated in FIG. 1 according to an exemplary embodiment of the inventive concept;

FIG. 11 is a block diagram of an example of the hub illustrated in FIG. 1;

FIG. 12 is a block diagram of an example of the hub illustrated in FIG. 1;

FIG. 13 is a block diagram of an example of the hub illustrated in FIG. 1;

FIG. 14 is a block diagram of an example of the hub illustrated in FIG. 1;

FIG. 15 is a block diagram of an example of the hub illustrated in FIG. 1;

FIG. 16 is a block diagram of a data processing system including the hub illustrated in FIG. 1 according to an exemplary embodiment of the inventive concept;

FIG. 17 is a block diagram of a data processing system including the hub illustrated in FIG. 1 according to an exemplary embodiment of the inventive concept;

FIG. 18 is a block diagram of a data processing system including the hub illustrated in FIG. 1 according to an exemplary embodiment of the inventive concept;

FIG. 19 is a block diagram of a data processing system including the hub illustrated in FIG. 1 according to an exemplary embodiment of the inventive concept; and

FIG. 20 is a block diagram of a data processing system including the hub illustrated in FIG. 1 according to an exemplary embodiment of the inventive concept.

### DETAILED DESCRIPTION

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present.

As used herein, the singular forms “a”, “an” and “the” are intended to include the plural forms as well, unless the context clearly indicates otherwise.

Pairing is a procedure for registering information (e.g., pairing information) associated with a second device (e.g., an internet of thing (IoT) device) in a first device (e.g., a master device or a hub) in order to wirelessly connect the second device to the first device. In an exemplary embodiment, a hub is a network hardware device for connecting multiple devices together. Hereinafter, pairing for authentication may be referred to as pairing authentication. Once the first device and the second device are paired with each other, no more pairing may be necessary between the first and second devices since the pairing information of the second device has been registered in the first device. However, when the pairing information of the second device is deleted from the first device, pairing between the first and second devices may need to be performed again.

It is assumed that a thing collectively refers to an integrated circuit, a semiconductor device, a semiconductor package, an electronic device, or an IoT device. The semiconductor device may be implemented as a module or a system in package (SiP).

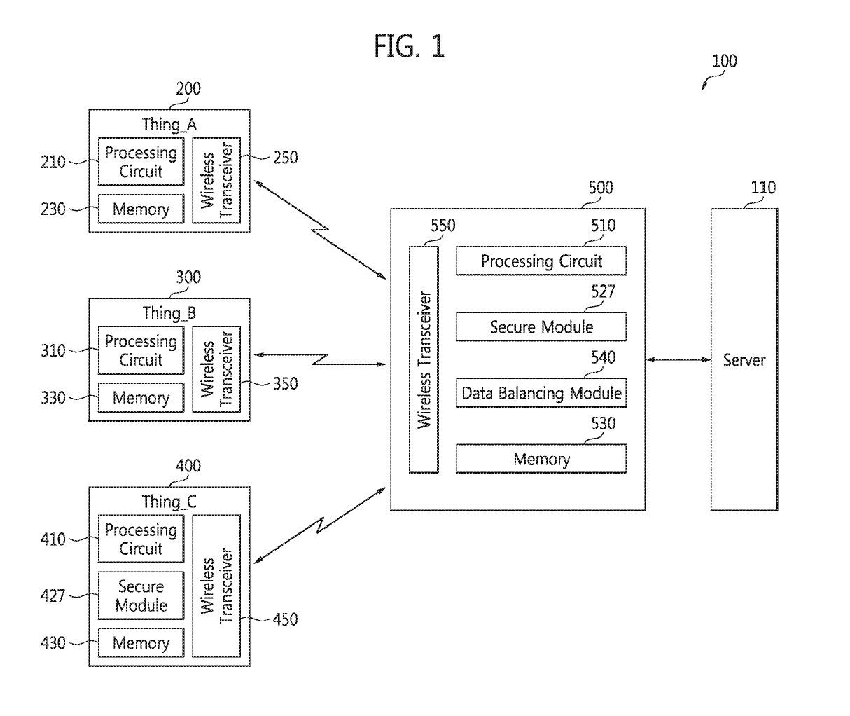

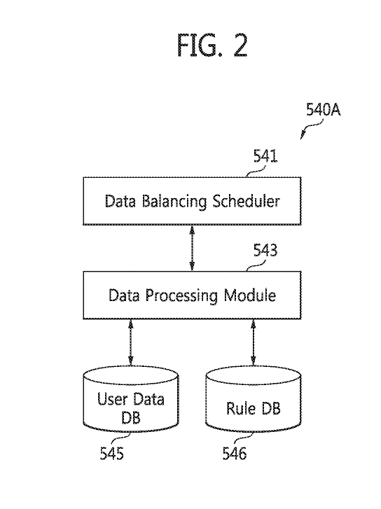

FIG. 1 is a block diagram of a data processing system 100 according to an exemplary embodiment of the inventive concept. FIG. 2 is a block diagram of an example 540A of a data balancing module 540 illustrated in FIG. 1. Referring to FIGS. 1 and 2, the data processing system 100 may include a plurality of IoT devices 200, 300, and 400, at least one hub 500, and at least one server 110.

Each of the first through third IoT devices 200, 300, and 400 may be a device (or a thing) connected to the hub 500 without security authentication, a device (or a thing) connected to the hub 500 with limited security authentication, or a device (or a thing) connected to the hub 500 using a security authentication platform. In an embodiment, the security level of the second IoT device 300 is higher than that of the first IoT device 200 and the security level of the third IoT device 400 is higher than that of the second IoT device 300. The third IoT device 400 and the hub 500 may use the security platform provided on https://www.artik.io/, but the inventive concept is not limited thereto. For example, the security platform may be SAMSUNG ARTIK.

As described above, each of the devices 200, 300, 400, and 500 may be implemented as an IoT device, but the inventive concept is not limited thereto. The IoT device, which will be described hereinafter, may include an accessible interface (e.g., a wired interface and/or a wireless interface). The IoT device may refer to a device which can communicate data (via wired or wireless connection) with at least one electronic device (or another IoT device) using the accessible interface.

The accessible interface may include a local area network (LAN), a wireless LAN (WLAN) like wireless fidelity (Wi-Fi), a wireless personal area network (WPAN) like Bluetooth, a wireless universal serial bus (USB), ZigBee, near field communication (NFC), radio-frequency identification (RFID), or a mobile cellular network, but the inventive concept is not restricted thereto. The mobile cellular network may include a third generation (3G) mobile cellular network, a fourth generation (4G) mobile cellular network, a long term evolution (LTE™) mobile cellular network, or an LTE-advanced (LTE-A) mobile cellular network, but the inventive concept is not limited thereto.

The first IoT device 200 includes a processing circuit 210, a memory 230, and a communication module 250. The processing circuit 210 may control the memory 230 and the communication module 250. The processing circuit 210 may be an integrated circuit (IC), a processor, or a central processing unit (CPU). The processing circuit 210 may communicate a command and/or data for pairing with the hub 500 through the communication module 250. When the first IoT device 200 includes at least one sensor, the processing circuit 210 may process a signal detected by the sensor and may transmit the processed signal to the hub 500 through the communication module 250.

The memory 230 may store data which has been processed or will be processed by the processing circuit 210 or the communication module 250. The communication module 250 may communicate a command and/or data with the hub 500 according to the control of the processing circuit 210. The communication module 250 may be a wireless transceiver and may communicate with the hub 500 through the above-described accessible interface.

The second IoT device 300 includes a processing circuit 310, a memory 330, and a communication module 350. The processing circuit 310 may control the memory 330 and the communication module 350. The processing circuit 310 may be an IC, a processor, or a CPU. The processing circuit 310 may communicate a command and/or data for pairing with the hub 500 through the communication module 350. When the second IoT device 300 includes at least one sensor, the processing circuit 310 may process a signal detected by the sensor and may transmit the processed signal to the hub 500 through the communication module 350.

The memory 330 may store data which has been processed or will be processed by the processing circuit 310 or the communication module 350. The communication module 350 may communicate a command and/or data with the hub 500 according to the control of the processing circuit 310. The communication module 350 may be a wireless transceiver and may communicate with the hub 500 through the above-described accessible interface.

The third IoT device 400 includes a processing circuit 410, a secure module 427, a memory 430, and a communication module 450. The processing circuit 410 may control the secure module 427, the memory 430, and the communication module 450. The processing circuit 410 may be an IC, a processor, or a CPU. The processing circuit 410 may communicate a command and/or data for pairing with the hub 500 through the communication module 450. The secure module 427 may be a hardware secure module and may convert data (e.g., unencrypted data) which has been processed or will be processed by the processing circuit 410 into secure data (e.g., encrypted data). The secure module 427 may also convert data (e.g., unencrypted data) which has been processed or will be processed by the communication module 450 into secure data (e.g., encrypted data).

When the third IoT device 400 includes at least one sensor, the processing circuit 410 may process a signal detected by the sensor and may transmit the processed signal to the hub 500 through the communication module 450. At this time, the secure module 427 may convert data to be transmitted to the communication module 450 into secure data.

The memory 430 may store data which has been processed or will be processed by the processing circuit 410 or the communication module 450. The communication module 450 may communicate a command and/or data with the hub 500 according to the control of the processing circuit 410. The communication module 450 may be a wireless transceiver and may communicate with the hub 500 through the above-described accessible interface.

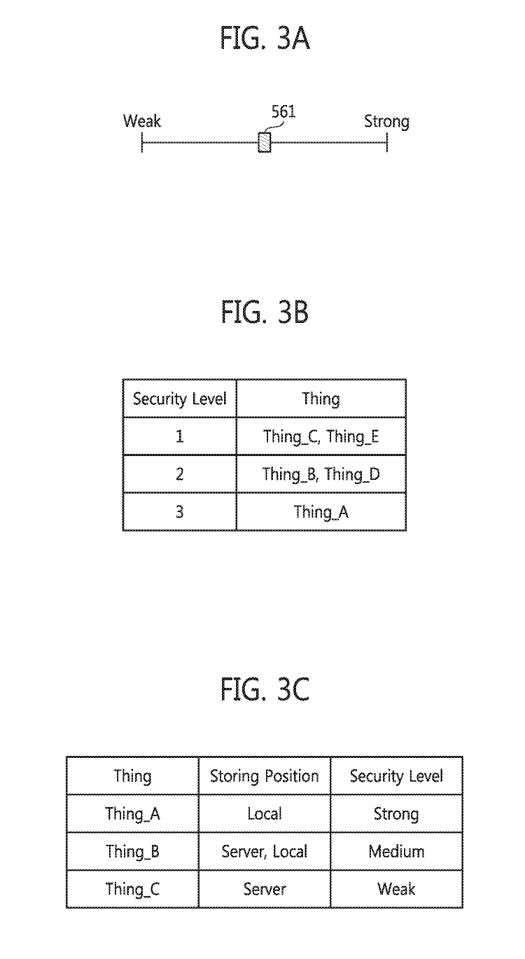

The hub 500 may include a processing circuit 510, a secure module 527, a memory 530, the data balancing module 540, and a communication module 550. The processing circuit 510 may control the secure module 527, the memory 530, the data balancing module 540, and the communication module 550. The processing circuit 510 may be an IC, a processor, or a CPU. The processing circuit 510 may communicate a command and/or data for pairing with each of the IoT devices 200, 300, and 400 through the communication module 550. The secure module 527 may be a hardware secure module and may convert data (e.g., unencrypted data) processed or to be processed by the processing circuit 510 into secure data (e.g., encrypted data). The secure module 527 may also convert data (e.g., un-encrypted data) processed or to be processed by the communication module 550 into secure data (e.g., encrypted data). In addition, the secure module 527 may encrypt user data, which is determined to be encrypted according to a user data management rule, using an encryption key. The user data management rule will be described in detail with reference to FIGS. 3A through 3C below.

The memory 530 may store data which has been processed or will be processed by the processing circuit 510, the secure module 527, the data balancing module 540, or the communication module 550. The memory 530 may include a secure region (or a secure memory) (not shown) which stores the secure data and a non-secure region (or a non-secure memory) (not shown) which stores non-secure data.

Each of the memories 230, 330, 430, and 530 may be formed of volatile or non-volatile memory. The memories 230, 330, 430, and 530 may be embedded in or removable from the devices 200, 300, 400, and 500, respectively. Each of the memories 230, 330, 430, and 530 may be implemented as a hard disk drive (HDD), a solid state drive (SSD), a universal flash storage (UFS), or an embedded multimedia card (eMMC), but the inventive concept is not limited thereto.

The communication module 550 may communicate a command and/or data with the each of the IoT devices 200, 300, and 400 according to the control of the processing circuit 510. The communication module 550 may be a wireless transceiver and may communicate with the IoT devices 200, 300, and 400 through the above-described accessible interface.

The hub 500 may also include another communication module for communicating with another server when there are more than one server 110.

In an exemplary embodiment, the processing circuit 510 receives a pairing request from one or more of the IoT devices 200, 300, or 400, selects an authentication technique from among predetermined pairing authentication techniques (or methods) based on the pairing request, and performs a pairing with the corresponding one or more IoT devices 200, 300, or 400 using the selected authentication technique. The processing circuit 510 may control or manage the pairing with each of the IoT devices 200, 300, and 400. In an exemplary embodiment, the processing circuit 510 checks authentication history in response to the pairing request from one or more of the IoT devices 200, 300, or 400, performs authentication using a pairing authentication technique suitable to the corresponding one or more IoT devices 200, 300, or 400 when there is no authentication history to generate an authentication result, and controls or manages the storing of the authentication result. The authentication result may be stored in the processing circuit 510 or the secure region of the memory 530, but the inventive concept is not limited thereto.

In an exemplary embodiment, the processing circuit 510 registers, changes, or removes information of one or more of the IoT devices 200, 300, and 400. The processing circuit 510 may also provide a user interface and a basic template to allow a user to set, change, or cancel a data management rule. In addition, the processing circuit 510 may authenticate a user using user authentication information. The user authentication information may be a user's fingerprint, a password, or personal identification information (such as an internet personal identification number (I-PIN) or a resident registration number), but the inventive concept is not limited to these examples. The user authentication information may be stored in the secure module 527 or in memory 530.

For instance, when a user makes a request for setting, changing, or cancelling a data management rule; the processing circuit 510 may give permission for the user to set, change, or cancel the data management rule after authenticating the user by authenticating the user authentication information.

The data balancing module 540 may manage user data to be efficiently stored in at least one among the hub 500 and the server 110 according to the user data management rule. The data balancing module 540 may also manage so that sensitive data among the user data is processed according to the user data management rule to generate processed data and the processed data is transmitted to the server 110. The data management rule may include a type of sensitive data, the security level of the sensitive data, and the storing place (or storing position) of the sensitive data, but the inventive concept is not limited to these examples.

FIGS. 3A through 3C are diagrams for explaining a user data management rule according to an exemplary embodiment of the inventive concept. FIG. 3A shows an example of the basic template of a data management rule, which is provided by the hub 500.

Referring to FIG. 3A, the basic template is provided to set the security level of sensitive data. The hub 500 may display the basic template shown in FIG. 3A on a user terminal so that a user can set a security level by moving a control button 561. For instance, when the user moves the control button 561 toward “strong”, the security level increases and when the user moves the control button 561 towards “weak”, the security level decreases. Data having a high security level may be sensitive data and a processing level of the sensitive data may increase, which will be described below.

The template of FIG. 3A used to set the security level may be individually provided for each of the IoT devices 200, 300, and 400. For instance, when one or more of the IoT devices 200, 300, or 400 is registered in the hub 500, the hub 500 may inform a user of the registration of the IoT device 200, 300, or 400 and may request that the user set the security level of the corresponding one or more IoT devices 200, 300, or 400.

FIG. 3B shows an example of setting a user data management rule by setting a thing corresponding to each security level. In the example illustrated in FIG. 3B, the security level is divided into level 1, level 2, and level 3 and there are five things, i.e., Thing_A, Thing_B, Thing_C, Thing_D, and Thing_E that have been registered in the hub 500, but the inventive concept is not limited to the current example. The user may set the user data management rule by setting Thing_A to security level 3, Thing_B and

Thing_D to security level 2, and Thing_C and Thing_E to security level 1. Data with a security level of a high numeral is sensitive data, and therefore, the processing level of the data may increase.

FIG. 3C shows an example of setting a user data management rule by setting a security level and a storing position for each thing. In the example shown in FIG. 3C, the security level is divided into “strong”, “medium”, and “weak” and there are three things, i.e., Thing_A, Thing_B, and Thing_C that have been registered in the hub 500, but the inventive concept is not limited to the current example. A user may set the user data management rule by setting the security level to “strong” and the storing position to “local” (e.g., the hub 500) for Thing_A, setting the security level to “medium” and the storing position to “server” and “local” for Thing_B, and setting the security level to “weak” and the storing position to “server” for Thing_C. Here, that the storing position is set to “local” for a thing means that data of the thing is stored in the hub 500 and that the storing position is set to “server” for a thing means that data of the thing is stored in the server 110. Alternatively, the storing position of sensitive data may be automatically set by the hub 500.

Referring back to FIG. 2, the data balancing module 540A includes a data balancing scheduler 541, a data processing module 543, a user data database (DB) 545, and a user data management rule DB 546. Each of the elements 541, 543, 545, and 546 may be implemented as a hardware component or as a software component which can be executed in the processing circuit 510. Alternatively, some of the elements 541, 543, 545, and 546 may be implemented as hardware components while the rest of the elements 541, 543, 545, and 546 are implemented as software components.

The data balancing scheduler 541 may control the number of times that data processed by the data processing module 543 is transmitted to the server 110 and a time (or an interval) at which the data is transmitted. For example, data may be transmitted to the server 110 by the data processing module 543 periodically at a period defined or controlled by the data balancing scheduler 541. The data processing module 543 may process sensitive data among user data according to a user data management rule.

A sensitive data processing method may include hiding all or part of sensitive data so that the sensitive data cannot be distinguished. The method may also include computing trend information of sensitive data in a particular time unit (e.g., daily, weekly, or monthly). The trend information may be obtained by performing an arithmetic operation (e.g., averaging or addition) on at least two data sets, by selecting a data set from among at least two data sets, or by comparing at least two data sets with each other. Alternatively, the trend information may be computed by comparing a current value obtained by performing an arithmetic operation (e.g., averaging or addition) on at least two data sets or by selecting a data set from among at least two data sets with a previous value. The trend information may indicate “increase”, “no change”, or “decrease”.

The processing method of hiding all or part of sensitive data to be undistinguishable may include at least one among a process of encrypting the sensitive data and a processing of blurring the sensitive data. The sensitive data encryption process may mean encrypting all of the sensitive data into data that cannot be distinguished in the server 110. Accordingly, the server 110 receives undistinguishable data from the hub 500 and stores it.

When necessary, the hub 500 may receive the “encrypted data” from the server 110 and decrypt the encrypted data, thereby restoring original data. In an embodiment, the server 110 cannot use the encrypted data and the server 110 is just used as a place for storing the encrypted data.

A sensitive data blurring process may be referred to as a sensitive data obfuscation process. The blurring or obfuscation process means processing part of sensitive data so that the part of the sensitive data cannot be distinguished in the server 110 or hiding (e.g., performing a mosaic process on) part of the sensitive data. In an embodiment, the sensitive blurring process is a process of hiding original data with random characters or data.

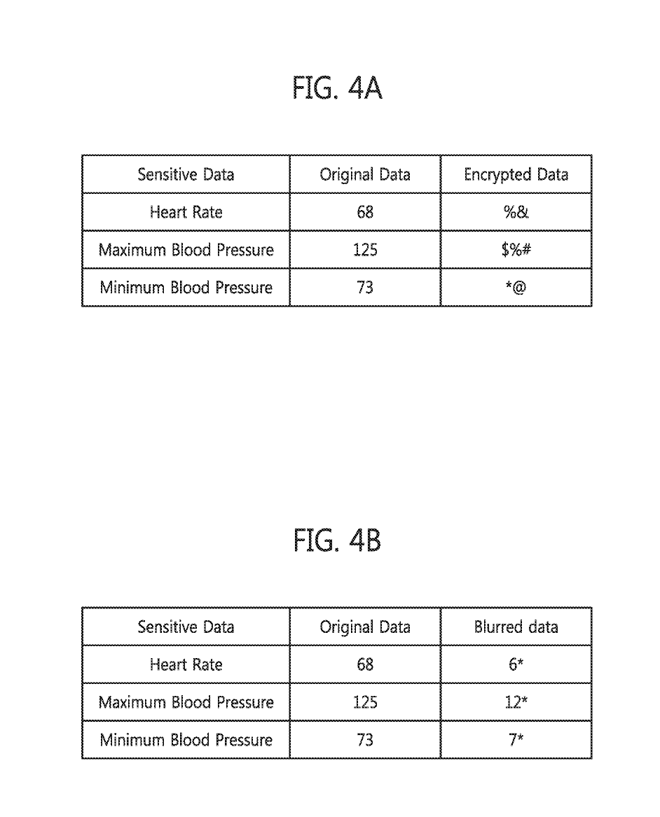

FIG. 4A is a diagram for explaining the sensitive data encryption process and FIG. 4B is a diagram for explaining the sensitive data blurring process. In the embodiments illustrated in FIGS. 4A and 4B, sensitive data includes biometric information such as a heart rate, a maximum blood pressure, and a minimum blood pressure. Referring to FIGS. 4A and 4B, encrypted data may be generated so that all original data cannot be distinguished at all while blurred data may be generated so that only part of the original data cannot be distinguished. For example, when only part of the original data cannot be distinguished from the resulting data, some characters of the resulting data may match characters of the original data in value and position. While FIG. 4B shows that a character of the original data is replaced with an invalid number such as asterisk to create the blurred data, the inventive concept is not limited thereto. For example, a character of the original data could instead be replaced with a valid number so it would not be apparent that blurring has occurred.

The hub 500 transmits processed data such as blurred data or trend information to the server 110 for sensitive data according to a user data management rule, thereby increasing the security of the sensitive data and allowing the server 110 to analyze and use the processed data.

Referring back to FIG. 2, the user data DB 545 stores and manages user data received from the IoT devices 200, 300, and 400. The user data management rule DB 546 stores and manages user data management rule information. In addition, the user data management rule DB 546 may store and manage a basic data management rule defined by a developer or the like.

As described above, the user data management rule is a data management rule set by a user. The basic data management rule or/and the user data management rule may be written using an extensible markup language (XML) or a hypertext markup language (HTML).

The hub 500 may provide a basic template for allowing a user to set or change the data management rule through a user interface. The hub 500 may include a user interface unit for providing a user a basic template and receiving a user's input or selection. Alternatively, a user may be allowed to access the hub 500 and set or change the data management rule using a user terminal such as a personal computer (PC), a tablet PC, or a smart phone.

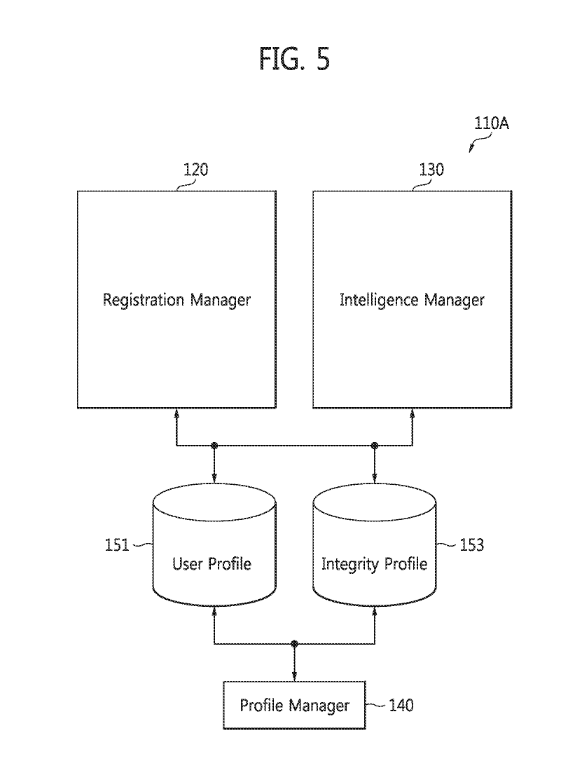

FIG. 5 is a block diagram of an example 110A of the server 110 illustrated in FIG. 1. Referring to FIG. 5, the server 110A includes a registration manager 120, an intelligence manager 130, a profile manager 140, a user profile 151, and an integrity profile 153.

The registration manager 120 may manage the registration, change, and removal of the IoT devices 200, 300, and 400. The registration manager 120 may receive a request of registration for one or more of the IoT devices 200, 300, or 400 from the hub 500 and may register the corresponding one or more IoT devices 200, 300, or 400 in response to the request. The registration manager 120 may perform authentication of the corresponding one or more IoT devices 200, 300, or 400 or the hub 500 before registering the corresponding one or more IoT devices 200, 300, or 400.

The registration manager 120 may also receive user data from the hub 500 and store the user data in the user profile 151. For instance, the registration manager 120 may classify the data of the IoT device 200, 300, or 400 by homes, hubs, clusters, or IoT devices when storing the data in the user profile 151.

The registration manager 120 may determine one of a plurality of cluster types as a cluster type of a corresponding one of the IoT devices 200, 300, or 400 according to information and/or data of the corresponding one of the IoT devices 200, 300, or 400. For instance, the registration manager 120 may classify a device connected to the hub 500 without secure authentication as a first cluster type, a device connected to the hub 500 with limited secure authentication as a second cluster type, and a device connected to the hub 500 using an secure authentication platform as a third cluster type. The registration manager 120 may classify IoT devices such as sensors or home gadgets as the first cluster type, IoT devices such as smart television (TV) or smart phones as the second cluster type, and IoT devices such as smart home appliances as the third cluster type.

The intelligence manager 130 analyzes IoT data stored in the user profile 151 and supports a service to be provided for a user based on analyzed information. For instance, the intelligence manager 130 may collectively analyze the data of the IoT devices 200, 300, and 400 to generate the analyzed information and may compute a relationship between the things from the analyzed information. The analyzed information and the relationship between the things which have been computed by the intelligence manager 130 may be stored in the integrity profile 153.

The intelligence manager 130 may generate or support a service based on data stored in the integrity profile 153. The profile manager 140 may manage and control the user profile 151 and the integrity profile 153.

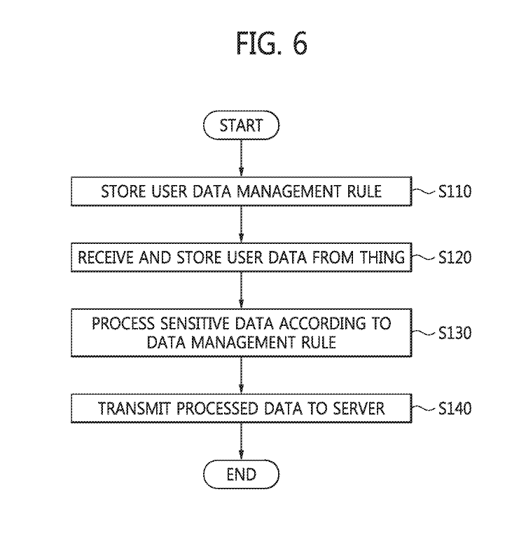

FIG. 6 is a schematic flowchart of a method of operating the hub 500 according to an exemplary embodiment of the inventive concept. Referring to FIGS. 1, 2, and 6, the hub 500 may store a user data management rule in the user data management rule DB 546 in operation S110. For instance, the hub 500 may have a basic data management rule stored in advance and display the basic data management rule for a user to allow the user to change the basic data management rule to be suitable to the user. The hub 500 may provide a basic template to allow the user data management rule to be set or changed through a user interface. The user may access the hub 500 and set, change, or cancel the user data management rule using a user terminal such as a smart phone, a PC, or a tablet PC.

The hub 500 may first perform authentication of the user using user authentication information before allowing the user to set, change, or cancel the user data management rule. The user authentication information may be the user's fingerprint, password or personal identification information (such as an I-PIN or a resident registration number), but the inventive concept is not limited to these examples. The user authentication information may be stored in the secure module 527. The processing circuit 510 of the hub 500 may compare the user authentication information stored in the secure module 527 with authentication information input by the user to generate a comparison result and authenticate the user according to the comparison result.

The hub 500 receives user data from one of the IoT devices 200, 300, or 400 (e.g., a thing) and stores the user data in operation S120. The data processing module 543 included in the hub 500 processes sensitive data among the user data according to the user data management rule to generate processed data in operation S130. The hub 500 transmits the processed data to the server 110 in operation S140.

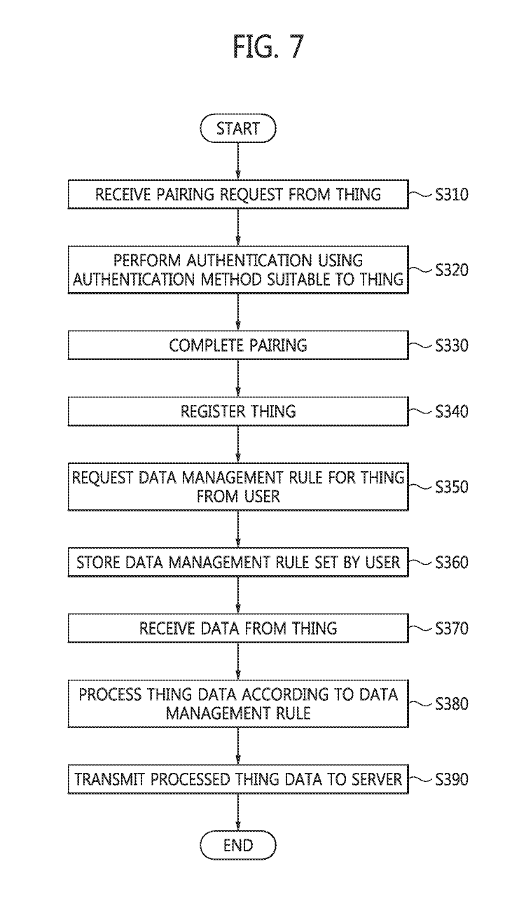

FIG. 7 is a detailed flowchart of a method of operating the hub 500 according to an exemplary embodiment of the inventive concept. Referring to FIGS. 1 and 2 and FIG. 7, the hub 500 receives a pairing request from one of the IoT devices 200, 300, or 400 in operation 5310. The hub 500 performs authentication of the corresponding one of the IoT devices 200, 300, or 400 using one of a plurality of predetermined authentication techniques in operation 5320.

For instance, the hub 500 may select an authentication technique from among a plurality of pairing authentication techniques using an authentication request signal included in the pairing request from the corresponding one of the IoT devices 200, 300, or 400 and may authenticate the corresponding one of the IoT devices 200, 300, or 400 using the selected authentication technique. The authentication request signal may include an ID, a password, a media access control (MAC) address, a Wi-Fi protected access (WPA)-related signal, a WPA2-related signal, a digital signature, an ID-based encryption (IBE)-related signal, or a biometrics-related signal.

After authenticating the corresponding one of the IoT devices 200, 300, or 400, the hub 500 completes pairing with the corresponding one of the IoT devices 200, 300, or 400 in operation 5330 and registers pairing information of the corresponding one of the IoT devices 200, 300, or 400 which has been successfully paired with the hub 500 in operation S340. Once the pairing information of the corresponding one of the IoT devices 200, 300, or 400 is registered, the hub 500 requests the user to set a data management rule for the corresponding one of the IoT devices 200, 300, or 400 that has been registered in operation S350. For instance, the hub 500 may notify the user that the corresponding one of the IoT devices 200, 300, or 400 has been registered and may display a basic template showing a basic data management rule for the corresponding one of the IoT devices 200, 300, or 400 in operation S350.

When the user sets the data management rule using the basic template, the hub 500 stores the data management rule set by the user in the user data management rule DB 546 in operation S360. When the user does not set or change the data management rule, the hub 500 may use the predetermined basic data management rule.

The hub 500 receives user data from the corresponding one of the IoT devices 200, 300, or 400 and stores the user data in the user data DB 545 in operation S370. The corresponding one of the IoT devices 200, 300, or 400 may access the hub 500 and transmit the user data to the hub 500 at a predetermined interval or time or when an event occurs. The hub 500 processes the user data according to the data management rule to generate processed data in operation S380 and transmits the processed data (e.g., processed thing data) to the server 110 in operation S390.

The order of operations may be changed or at least two operations may be performed in parallel in other embodiments.

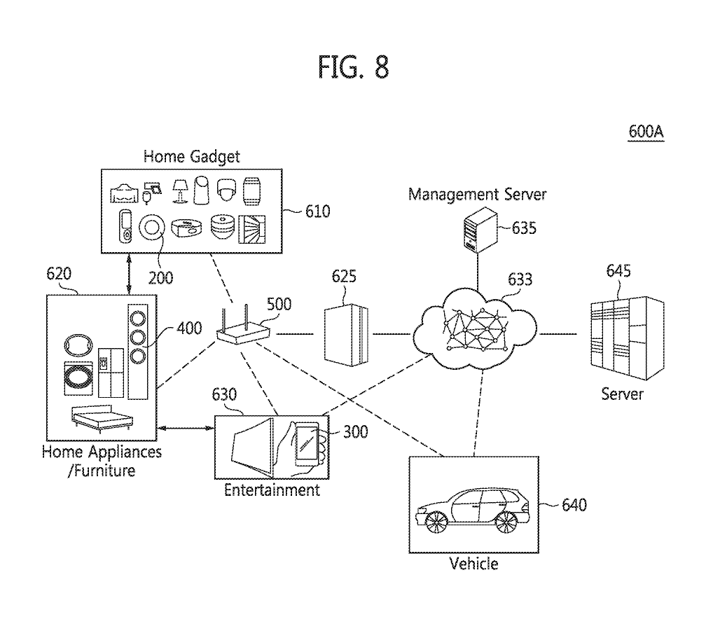

FIG. 8 is a block diagram of a data processing system 600A including the hub 500 illustrated in FIG. 1 according to an exemplary embodiment of the inventive concept. Referring to FIGS. 1 through 8, the data processing system 600A may include the hub 500 and IoT devices 610, 620, 630, and 640.

It is assumed that the structure of the IoT devices 610 is the same as or similar to that of the first IoT device 200, the structure of the IoT devices 630 is the same as or similar to that of the second IoT device 300, and the structure of the IoT devices 620 and 640 is the same as or similar to that of the third IoT device 400.

An IoT or the data processing system 600A may refer to a network among IoT devices that use wired and/or wireless communication. Accordingly, an IoT here may be referred to as an IoT network system, a ubiquitous sensor network (USN) communication system, a machine type communication (MTC) system, a machine-oriented communication (MOC) system, a machine-to-machine (M2M) communication system, or a device-to-device (D2D) communication system.

Here, an IoT network system may include elements, such as, an IoT device, the hub 500, an access point, a gateway, a communication network, and/or a server. However, these elements are defined just to explain the IoT network system and the scope of the IoT network system is not limited to these elements. In an embodiment, the gateway is a piece of networking hardware used to exchange data between two different communication protocols.

The IoT network system may use a user datagram protocol (UDP), a transmission protocol like a transmission control protocol (TCP), an IPv6 low-power wireless personal area networks (6LoWPAN) protocol, An IPv6 internet routing protocol, a constrained application protocol (CoAP), a hypertext transfer protocol (HTTP), a message queue telemetry transport (MQTT), or an MQTT for sensors networks (MQTT-S) for exchange (or communication) of information among at least two elements therewithin.

When the IoT network system is implemented as a wireless sensor network (WSN), each of the IoT devices 200, 300, 400, 500, 610, 620, 630, and 640 may be used as a sink node or a sensor node. The sink node is referred to as a base station and acts as a gateway connecting the WSN with an external network (e.g., an internet). The sink node may assign a task to the sensor node and gather events sensed by the sensor node. The sensor node is a node within the WSN and may process and gather sensory information. The sensor node may communicate with other nodes in the WSN.

The IoT devices 200, 300, 400, 500, 610, 620, 630, and 640 may include an active IoT device which operates using its own power and a passive IoT device which operates using wireless power transferred from an outside source. The active IoT device may include a refrigerator, an air conditioner, a telephone, or an automobile. The passive IoT device may include a radio frequency Identification (RFID) tag or a near field communication (NFC) tag. However, when an RFID tag or an NFC tag includes a battery, the RFID or NFC tag may be classified as an active IoT device.

The IoT devices 200, 300, 400, 500, 610, 620, 630, and 640 may include a passive communication interface such as a two-dimensional barcode, a three-dimensional barcode, a quick response (QR) code, an RFID tag, or an NFC tag. The IoT devices 200, 300, 400, 500, 610, 620, 630, and 640 may also include an active communication interface such as a modem or a transceiver.

At least one of the IoT devices 200, 300, 400, 610, 620, 630, and 640 may transmit and receive control information and/or data through a wired or wireless communication interface. The wired or wireless communication interface may be an example of an accessible interface.

The hub 500 in the IoT network system 600A may function as an access point. The IoT devices 200, 300, 400, 610, 620, 630, and 640 may be connected to a communication network or other IoT devices through the hub 500.

Although the hub 500 is shown as an independent device in FIG. 8, the hub 500 may be embedded in one of the IoT devices 400, 610, 620, 630, and 640. For example, the hub 500 may be embedded in a television (TV or a smart TV) or a smart refrigerator. At this time, a user may be allowed to monitor or control at least one of the IoT devices 400, 610, 620, 630, and 640 connected to the hub 500 through a display of the TV or the smart refrigerator.

The hub 500 may be one of the IoT devices 400, 610, 620, 630, and 640. For example, a smart phone may be an IoT device functioning as the hub 500. For example, the smart phone may perform tethering. For example, when the smart phone is connected to another computer and performing tethering, the computer may gain access to the Internet through the smart phone.

The IoT network system 600A may also include a gateway 625. The gateway 625 may connect the hub 500, which functions as an access point, to an external communication network (e.g., an internet or a public switched network). Each of the IoT devices 200, 300, 400, 500, 610, 620, 630, and 640 may be connected to an external communication network through the gateway 625. In an embodiment, the hub 500 and the gateway 625 are implemented in a single device. Alternatively, the hub 500 may function as a first gateway and the gateway 625 may function as a second gateway.

One of the IoT devices 200, 300, 400, 500, 610, 620, 630, and 640 may function as the gateway 625. For example, a smart phone may be both an IoT device and the gateway 625. The smart phone may be connected to a mobile cellular network.

The IoT network system 600A may also include a gateway 625 and at least one communication network 633. The communication network 633 may include an internet and/or a public switched network, but the inventive concept is not limited thereto. The public switched network may include a mobile cellular network. The communication network 633 may be a communication channel which transfers information gathered by the IoT devices 610, 620, 630, and 640.

The IoT network system 600A may also include a management server 635 and/or a server 645 connected to the communication network 633. The communication network 633 may transmit a signal (or data) detected by at least one of the IoT devices 610, 620, 630, and 640 to the management server 635 and/or the server 645.

The management server 635 and/or the server 645 may store or analyze a signal received from the communication network 633. The management server 635 and/or the server 645 may perform the same operations as or similar operations to the server 110A illustrated in FIG. 5.

The management server 635 and/or the server 645 may transmit the analysis result to at least one of the IoT devices 610, 620, 630, and 640 via the communication network 633. For example, the management server 635 may manage the states of the hub 500, the gateway 625, the communication network 633, and/or each of the IoT devices 610, 620, 630, and 640.

The server 645 may receive and store data related with at least one of the IoT devices 610, 620, 630, and 640 and may analyze the stored data to generate an analysis result. The server 645 may transmit the analysis result to at least one of the IoT devices 610, 620, 630, and 640 or to a device (e.g., a smart phone) possessed by a user via the communication network 633.

For example, when one of the IoT devices 610, 620, 630, and 640 is a blood glucose monitoring IoT device which measures a user's blood glucose; the server 645, which stores a blood glucose limit preset by the user, may receive a measured blood glucose level from the glucose monitoring IoT device via the communication network 633. In an embodiment, the server 645 compares the blood glucose limit with the measured blood glucose level and transmits a warning signal to at least one of the IoT devices 610, 620, 630, and 640 or a user device via the communication network 633 when the measured blood glucose level is higher than the blood glucose limit.

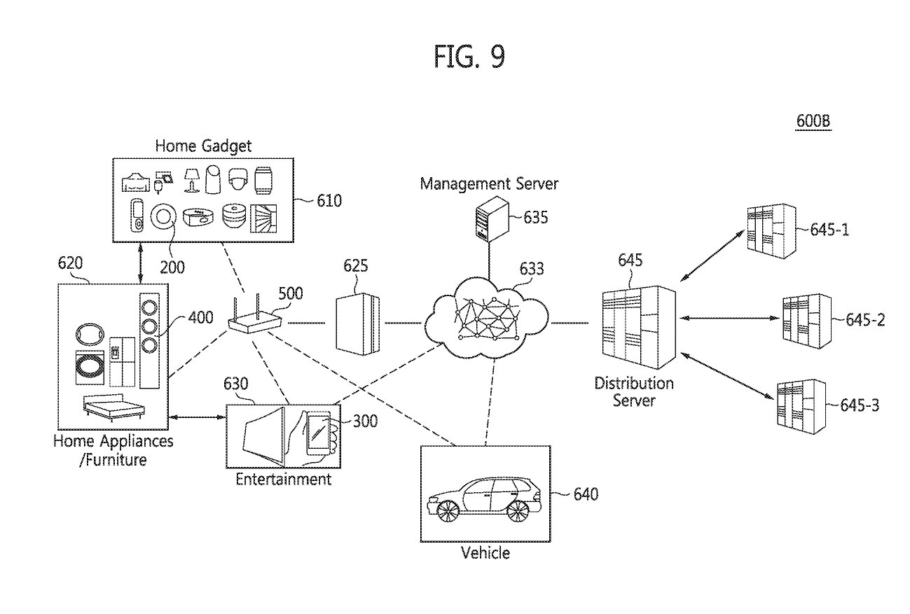

FIG. 9 is a block diagram of a data processing system 600B including the hub 500 illustrated in FIG. 1 according to an exemplary embodiment of the inventive concept. Referring to FIGS. 1 through 9, the IoT network system 600B may include a hub 500, a smart phone 300, IoT devices 610, 620, 630, and 640, a gateway 625, a communication network 633, a management server 635, a distribution server 645, and a plurality of servers 645-1, 645-2, and 645-3.

Apart from the distribution server 645 and the servers 645-1, 645-2, and 645-3; the IoT network system 600B illustrated in FIG. 9 is the same as or similar to the IoT network system 600A illustrated in FIG. 8.

The distribution server 645 is connected with the servers 645-1, 645-2, and 645-3 and may distribute jobs to the servers 645-1, 645-2, and 645-3. The distribution server 645 may analyze a request transmitted from the communication network 633 through scheduling to generate an analysis result, may predict the amount of data and workload related with a job based on the analysis result, and may communicate with at least one of the servers 645-1, 645-2, and 645-3. In an embodiment, the distribution server 645 receives and analyzes state information from the servers 645-1, 645-2, and 645-3 and applies the analysis result to the scheduling. The overall performance of the IoT network system 600B may be enhanced through the scheduling of the distribution server 645.

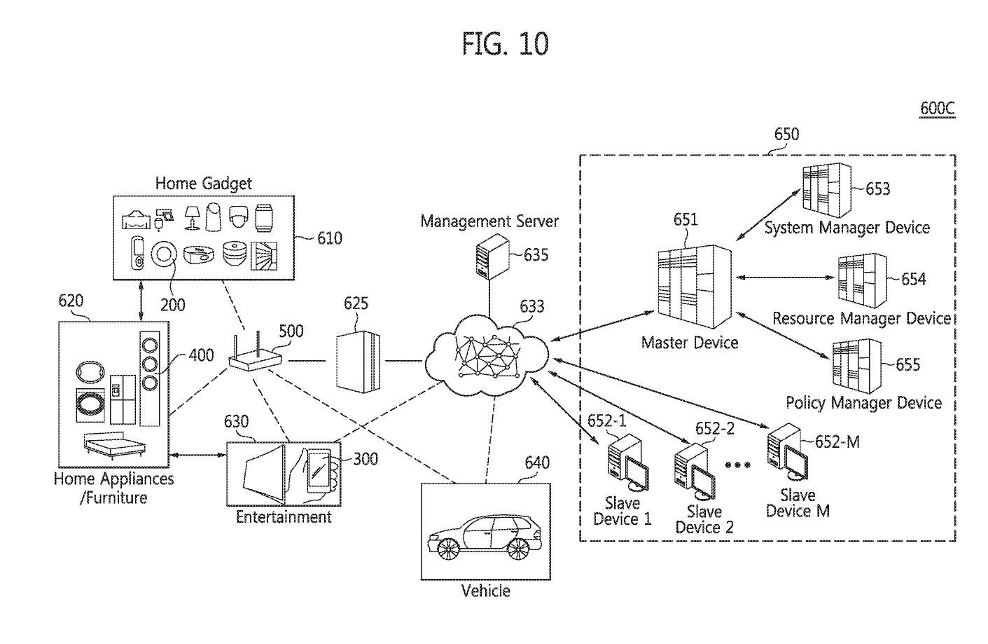

FIG. 10 is a block diagram of a data processing system 600C including the hub 500 illustrated in FIG. 1 according to an exemplary embodiment of the inventive concept.

Referring to FIGS. 1 through 10, the IoT network system 600C may include a hub 500, a smart phone 300, IoT devices 610, 620, 630, and 640, a gateway 625, a communication network 633, a management server 635, and a distribution server system 650.

The distribution server system 650 may receive and store or analyze data from the communication network 633. The distribution server system 650 may send the stored data or the analyzed data to at least one of the elements 500, 625, 610, 620, 630, 625, and 640 included in the IoT network system 600C via the communication network 633.

In an exemplary embodiment, the distribution server system 650 includes a distributed computing system driven based on a distributed file system (DFS). For example, the distribution server system 650 may be driven based on at least one among various DFSs such as Hadoop DFS (HDFS), Google file system (GFS), Cloud store, Coda, network file system (NFS), and general parallel file system (GPFS), but the inventive concept is not limited to these examples.

In an exemplary embodiment, the distribution server system 650 includes a master device 651, slave devices 652-1 through 652-M (where M is a natural number of at least 3), a system manager device 653, a resource manager device 654, and a policy manager device 655. In an exemplary embodiment, less than 3 slave devices are present.

Each of the slave devices 652-1 through 652-M may store a data block. For example, data transmitted via the communication network 633 may be divided into data blocks by the master device 651. The data blocks may be stored in the slave devices 652-1 through 652-M in a distributed fashion. For example, when the distribution server system 650 is driven based on the HDFS, each of the slave devices 652-1 through 652-M may execute, as a data node, a task tracker to store at least one data block.

The master device 651 may divide data transmitted via the communication network 633 into data blocks. The master device 651 may provide each of the data blocks for at least one of the slave devices 652-1 through 652-M. For example, when the distribution server system 650 is driven based on the HDFS, the master device 651 may execute, as a name node, a job tracker to schedule the distribution of the data blocks. The master device 651 may manage distributed storage information indicating a stored position of each of the data blocks that have been distributed. The master device 651 may process a data store request and a data read request based on the distributed storage information.

The system manager device 653 may control and manage the overall operation of the distribution server system 650. The resource manager device 654 may manage the resource usage of each element included in the distribution server system 650. The policy manager device 655 may manage a policy on an access to each of the IoT devices 610, 620, 630, and 640 which are accessible via the communication network 633.

The master device 651, the slave devices 652-1 through 652-M, the system manager device 653, the resource manager device 654, and the policy manager device 655 each may include a universal computer like a personal computer (PC) and/or a dedicated computer like a workstation and each may include hardware modules for realizing a unique function. The master device 651, the slave devices 652-1 through 652-M, the system manager device 653, the resource manager device 654, and the policy manager device 655 each may perform a unique function by running software or firmware using a processor core.

As shown in FIG. 10, the master device 651 and the slave devices 652-1 through 652-M may share the communication network 633 with the IoT devices 610, 620, 630, and 640 and may transmit or receive data (or a data block) with one another via the communication network 633.

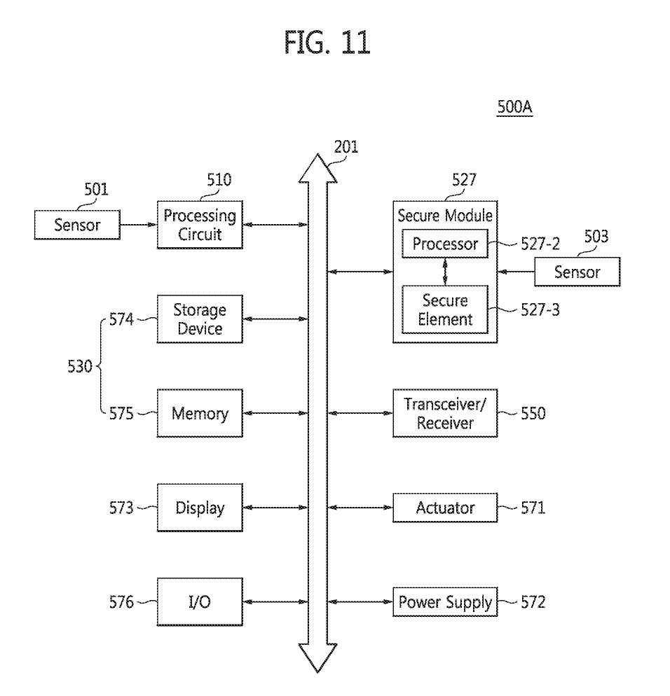

FIG. 11 is a block diagram of an example 500A of the hub 500 illustrated in FIG. 1 according to an exemplary embodiment of the inventive concept. Referring to FIGS. 1 and 11, the hub 500A may include a bus 201, a first sensor 501, a second sensor 503, a display 573, a secure module 527, a processing circuit 510, a communication module 550, an actuator 571, a power supply 572, a storage device 574, a memory 575, and an input/output (I/O) device 576. The storage device 574 and the memory 575 may be collectively represented by the memory 530. The secure module 527 may be implemented as a hardware secure module, but the inventive concept is not limited thereto.

The elements 530, 527, 530, 550, 571, 572, 573, and 576 may transmit or receive a command and/or data with one another via the bus 201.

The first sensor 501 may transmit a detection signal to the processing circuit 510. The display 573 may display data processed by the hub 500A or may provide a user interface (UI) or a graphical user interface (GUI) for a user.

The processing circuit 510 may control the overall operation of the hub 500A. The processing circuit 510 may execute an application providing an internet browser, a game, a moving image (e.g., video), a song, etc.

The communication module 550 may perform communication as a communication interface using LAN, WLAN like Wi-Fi, WPAN like Bluetooth, wireless USB, ZigBee, NFC, RFID, power line communication (PLC), or mobile cellular network. The communication module 550 may be implemented as a transceiver, a receiver, or a transmitter. The transceiver may include a receiver and a transmitter. In an embodiment, the receiver is referred to as a first communication module and the transmitter is referred to as a second communication module.

The storage device 574 may store a boot image for booting the hub 500A. For example, the storage device 574 may be implemented as an HDD, an SSD, an MMC, an eMMC, or a UFS.

The memory 575 may store data necessary for the operation of the hub 500A. For example, the memory 575 may include volatile memory and/or non-volatile memory.

The I/O device 576 may include an input device such as a touch pad, a keypad, or an input button and so on; and an output device like a speaker.

The second sensor 503 may be a biosensor which detects biometric information. For example, the second sensor 503 may detect a fingerprint, an iris pattern, a vein pattern, a heart rate, or blood glucose to generate a detection result; may generate detection data corresponding to the detection result; and may provide the detection data to a processor 527-2 of the secure module 527. However, the second sensor 503 is not limited to the biosensor and may be a luminance sensor, an acoustic sensor (e.g., an acoustic wave sensor), or an acceleration sensor (e.g., an accelerometer).

The secure module 527 may include the processor 527-2 and a secure element 527-3. The secure module 527 may be formed in a single package and a bus connecting the processor 527-2 and the secure element 527-3 may be formed within the package. The secure element 527-3 may have a function of defending against external attacks and thus be used to safely store secure data, e.g., the authentication information. The processor 527-2 may transmit or receive data with the processing circuit 510.

The secure module 527 may include a secure element 527-3. The secure module 527 and the processing circuit 510 may generate a session key through mutual authentication. The secure module 527 may encrypt data using the session key and transmit the encrypted data to the processing circuit 510. The processing circuit 510 may decrypt the encrypted data using the session key to generate decrypted detection data. Accordingly, the security level of data transmission in the hub 500A is increased. For example, the secure element 527-3 may be formed in a single package together with the processing circuit 510.

The processor 527-2 of the secure module 527 may encrypt detection data output from the second sensor 503 and may store the encrypted data in the secure element 527-3. The processor 527-2 may control communication between the processing circuit 510 and the secure element 527-3.

The actuator 571 may include various elements necessary for the physical driving of the hub 500A. For example, the actuator 571 may include a motor driving circuit and a motor controlled by the motor driving circuit. The power supply 572 may provide an operating voltage necessary for the operation of the hub 500A. The power supply 572 may include a battery.

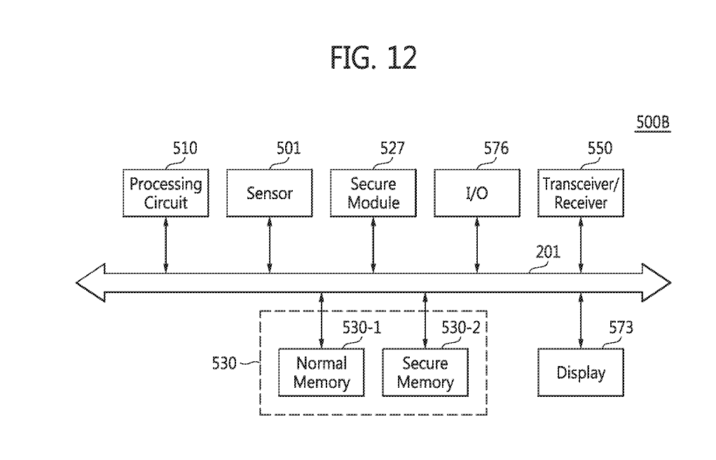

FIG. 12 is a block diagram of an example 500B of the hub 500 illustrated in FIG. 1 according to an exemplary embodiment of the inventive concept.

Referring to FIGS. 1 and 12, the hub 500B may include a first sensor 501, a display 573, a bus 201, a secure module 527, a processing circuit 510, a communication module 550, an I/O device 576, and a memory 530. The memory 530 may include a normal memory 530-1 and a secure memory 530-2. Although the normal memory 530-1 is implemented in the memory 530 in the embodiment illustrated in FIG. 12, the normal memory 530-1 may be implemented in the secure memory 530-2 in other embodiments.

The elements 501, 510, 527, 530, 550, 573, and 576 may transmit or receive data with one another via the bus 201.

The processing circuit 510 may control the overall operation of the hub 500B.

The normal memory 530-1 may store data necessary for the operation of the hub 500B. The normal memory 530-1 may be formed of volatile memory or non-volatile memory which stores data that does not require security. The secure memory 530-2 may store data that requires security in the operation of the hub 500B. Although the normal memory 530-1 and the secure memory 530-2 are separated from each other in the embodiments illustrated in FIG. 12, the normal memory 530-1 and the secure memory 530-2 may be formed in a single physical memory. For example, the memory 530 including the normal memory 530-1 and the secure memory 530-2 may be removably coupled to the hub 500B.

The structure and functions of the secure module 527 illustrated in FIG. 12 may be the same as or similar to those of the secure module 527 illustrated in FIG. 11.

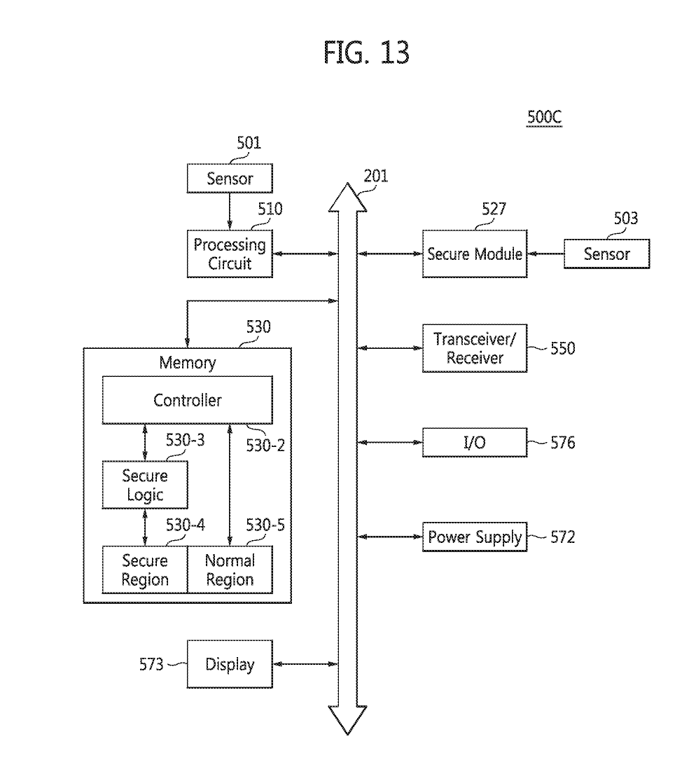

FIG. 13 is a block diagram of an example 500C of the hub 500 illustrated in FIG. 1 according to an exemplary embodiment of the inventive concept.

Referring to FIGS. 1 and 13, the hub 500C may include a first sensor 501, a second sensor 503, a display 573, a bus 201, a secure module 527, a processing circuit 510, a communication module 550, a memory 530, a power supply 572, and an I/O device 576. The elements 510, 530, 573, 527, 550, 576, and 572 may transmit or receive data with one another via the bus 201.

The processing circuit 510 may control the overall operation of the hub 500C. The first sensor 501 may transmit a detection signal to the processing circuit 510. The second sensor 503 may be a biosensor which detects biometric information.

The structure and functions of the secure module 527 illustrated in FIG. 13 may be the same as or similar to those of the secure module 527 illustrated in FIG. 11.

The memory 530 may store a boot image for booting the hub 500C. For example, the memory 530 may be implemented as flash memory, SSD, eMMC, or UFS. The memory 530 may include a secure region 530-4 and a normal region 530-5. A controller 530-2 may directly access the normal region 530-5 but may access the secure region 530-4 via a secure logic circuit 530-3. In other words, the controller 530-2 can access the secure region 530-4 only via the secure logic circuit 530-3.

The secure module 527 may store data output from the second sensor 503 in the secure region 530-4 of the memory 530 through communication with the secure logic circuit 530-3 of the memory 530.

The power supply 572 may provide an operating voltage necessary for the operation of the hub 500C.

The I/O device 576 may include an input device such as a touch pad, a keypad, an input button, etc.; and an output device like a speaker.

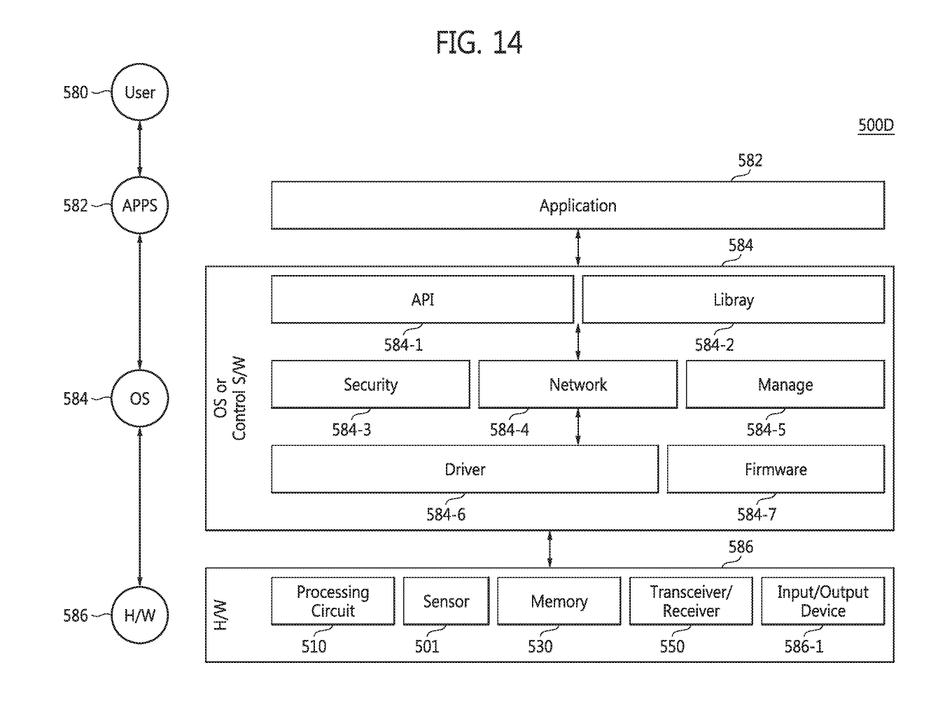

FIG. 14 is a block diagram of an example 500D of the hub 500 illustrated in FIG. 1 according to an exemplary embodiment of the inventive concept.

Referring to FIGS. 1 and 14, the hub 500D may include a processing circuit 510, a sensor 501, a communication module 550, a memory 530, and an I/O device 586-1.

The hub 500D may also include an application 582 and an operating system (OS) 584. FIG. 14 shows the layers of a user 580, the application 582, the OS 584, and a hardware component 586.

The application 582 may refer to software and/or service which performs a particular function. The user 580 may refer to a subject or object using the application 582. The user 580 may communicate with the application 582 using a UI.

The application 582 may be created based on a service purpose and may interact with the user 580 through the UI corresponding to the service purpose. The application 582 may perform an operation requested by the user 580 and may call an application protocol interface (API) 584-1 and the content of a library 584-2 if necessary.

The API 584-1 and/or the library 584-2 may perform a macro operation for a particular function or, when communication with a lower layer is necessary, may provide interface for the communication. When the application 582 requests a lower layer to operate through the API 584-1 and/or the library 584-2, the API 584-1 and/or the library 584-2 may classify the request as a security 584-3, a network 584-4, or a manage 584-5.

The API 584-1 and/or the library 584-2 runs a necessary layer according to the request.

For example, when the API 584-1 requests a function related with the network 584-4, the API 584-1 may transmit a parameter necessary for the network 584-4 to the network 584-4 and may call the relevant function. At this time, the network 584-4 may communicate with a relevant lower layer to perform a requested task. When there is no lower layer, the API 584-1 and/or the library 584-2 may perform the corresponding task by itself.

A driver 584-6 may manage the hardware component 586 and monitor the state of the hardware component 586. The driver 584-6 may receive a classified request from an upper layer and may deliver the request to the layer of the hardware component 586.

When the driver 584-6 requests the layer of the hardware component 586 to perform a task, firmware 584-7 may convert the request so that the layer of the hardware component 586 can accept the request. The firmware 584-7 which transmits the converted request to the hardware component 586 may be included in the driver 584-6 or be executed by the hardware component 586.

The hub 500D may include the API 584-1, the driver 584-6, and the firmware 584-7 and may be equipped with an OS that manages these elements 584-1, 584-6, and 584-7. The OS may be stored in the memory 530 in a form of control command codes and data. When the hub 500D is a low-price product, the hub 500D may include control software instead of the OS since the size of the memory 530 is small.

The hardware component 586 may execute requests (or commands) received from the driver 584-6 and/or the firmware 584-7 in order or out of order and may store the results of executing the requests in an internal register (not shown) of the hardware component 586 or in the memory 530. The results that have been stored may be returned to the driver 584-6 and/or the firmware 584-7.

The hardware component 586 may generate an interrupt to request an upper layer to perform an operation. When the interrupt is generated, the interrupt is checked in the manage 584-5 of the OS 584 and then processed by the hardware component 586.

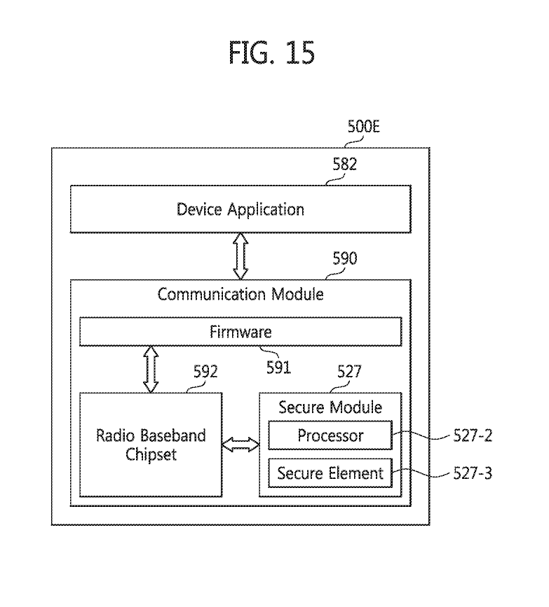

FIG. 15 is a block diagram of an example 500E of the hub 500 illustrated in FIG. 1 according to an exemplary embodiment of the inventive concept.

Referring to FIGS. 1 and 15, the hub 500E may include the device application 582 and a communication module 590. The communication module 590 may include firmware 591, a radio baseband chipset 592, and a secure module 527.

The device application 582, as a software component, may control the communication module 590 and may be executed by a CPU of the hub 500E. The communication module 590 may perform communication via LAN, WLAN like Wi-Fi, WPAN like Bluetooth, wireless USB, ZigBee, NFC, RFID, PLC, or mobile cellular network. For example, the communication module 590 may be the communication module 550.

The firmware 591 may provide the device application 582 and application programming interface (API) and may control the radio baseband chipset 592 according to the control of the device application 582. The radio baseband chipset 592 may provide connectivity for a wireless communication network. The secure module 527 may include the processor 527-2 and the secure element 527-3. The secure module 527 may authenticate the hub 500E in order to connect to the wireless communication network and to access a wireless network service. For example, the secure module 527 may be implemented as an eMMC, but the inventive concept is not limited thereto.

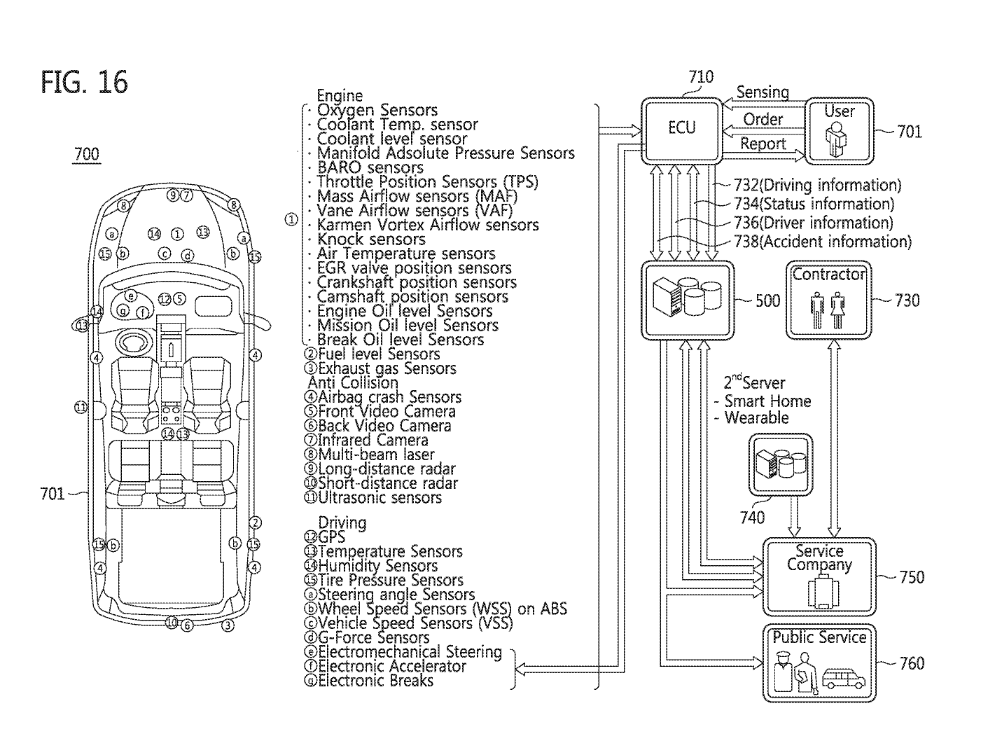

FIG. 16 is a block diagram of a data processing system 700 including the hub 500 illustrated in FIG. 1 according to an exemplary embodiment of the inventive concept.

Referring to FIGS. 1 through 7 and FIG. 16, the IoT network system 700 represents a usage scenario of vehicle management, collision prevention, or vehicle driving service and so on.

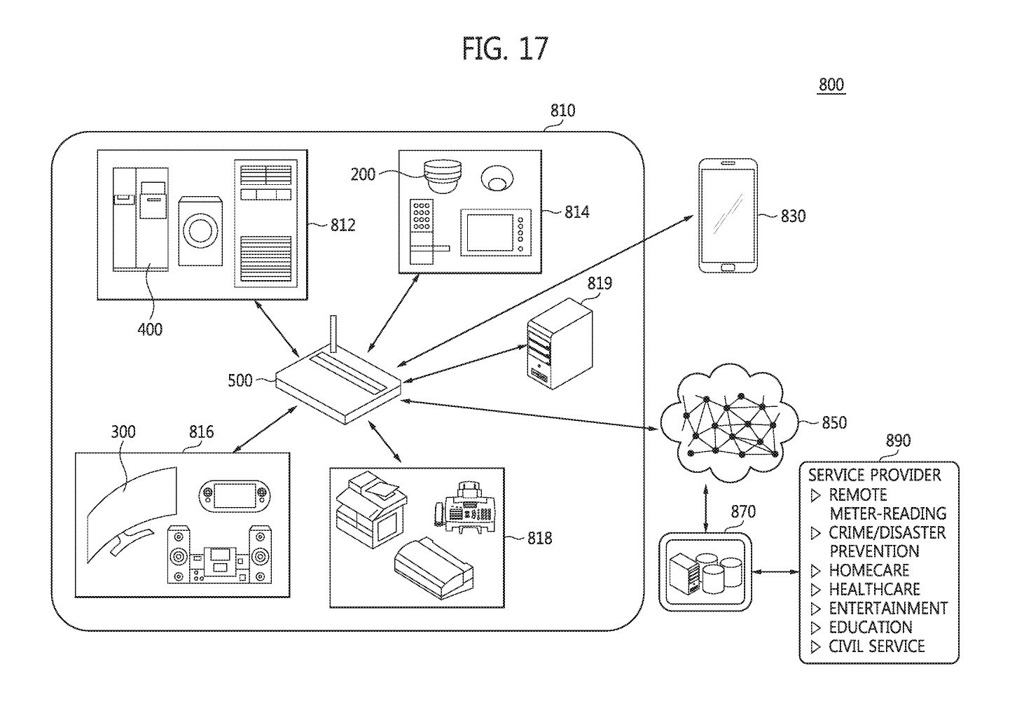

Referring to FIG. 17, the IoT network system 700 includes a vehicle 701 including sensors. The IoT network system 700 may also include an engine control unit (ECU) 710, a hub 500, and at least one service provider 750 and/or 760.

The sensors may include an engine unit sensor \textcircled{1}, collision prevention sensors \textcircled{4} through \textcircled{11}, and vehicle driving sensors \textcircled{12} through \textcircled{15} and \textcircled{a} through \textcircled{g}. The sensors may also include a fuel level sensor \textcircled{2} and/or an exhaust gas sensor \textcircled{3}.

The ECU 710 may gather driving information 732 output from the sensors and may transmit the driving information 732 to the hub 500 via a communication network. The hub 500 may perform the function of a data server. In an embodiment, the hub 500 is embedded in the data server.

The ECU 710 and the hub 500 may transmit or receive vehicle status information 734, driver information 736, and/or accident history information 738 with each other. Although the hub 500 is formed outside the ECU 710 in the embodiments illustrated in FIG. 16, the hub 500 may be formed inside the ECU 710 in other embodiments. The hub 500 may transmit information from the ECU 710 to a server of the service company 750.

The server of the service company 750 may provide a user's smart phone information obtained by analyzing the vehicle 701 with reference to the vehicle status information 734, the driver information 736, and/or the accident information 738 stored in the hub 500. For example, Services provided by the service company 750 may include information about accidents on the roads, a guide to the fast route, notification of accident handling, accident claim value calculation information, human-error rate estimation information, and/or emergency rescue service.

The server of the service company 750 may share vehicle-related information output from the hub 500 with a user 730 who has subscribed to the service. The user 730 may make a contract with the service company 750 based on the shared information.

The server of the service company 750 may receive a driver's personal information from a second server 740 and may activate an access control and service function for the vehicle 701 of the driver using the personal information. For example, the server of the service company 750 may receive NFC tag information stored in a user's wrist watch, compare the NFC tag information with NFC tag information stored in the second server 740, and unlock the door lock of the vehicle 701. The server of the service company 750 or the second server 740 may transmit the arrival information of the vehicle 701 to an IoT device installed at the user's home when the vehicle 701 arrives at the user's home.

A server of the public service provider 760 may send traffic information to an IoT device, e.g., a smart phone of the driver of the vehicle 701 based on the accident history information 738 stored in the hub 500.

FIG. 17 is a block diagram of a data processing system 800 including the hub 500 illustrated in FIG. 1 according to an exemplary embodiment of the inventive concept.

Referring to FIGS. 1 through 7 and FIG. 17, the IoT network system 800 may include a user's smart phone 830 and a home network system 810. The home network system 810 may include IoT devices 200, 300, 400, 812, 814, 816, and 818. In an exemplary embodiment, the IoT network system 800 includes a communication network 850, a server 870, and a service provider 890.

The home network system 810 may control various kinds of IoT devices in a building (e.g., a house, an apartment, or a high-rise) via a wired/wireless network and may share contents with the IoT devices. The home network system 810 may include a hub 500, IoT devices 812, 814, 816, and 818, and a home server 819.

The home appliance 812 may include a smart refrigerator (e.g., the third IoT device 400), a smart washing machine, an air conditioner, etc, but the inventive concept is not limited thereto. The security/safety equipment 814 may include a door lock, a closed circuit television (CCTV) (e.g., the first IoT device 200), an interphone, a window sensor, a fire detection sensor, or an electric plug and so on, but the inventive concept is not restricted thereto. The entertainment equipment 816 may include a smart TV (e.g., the second IoT device 300), an audio game machine, a computer, etc., but the inventive concept is not limited thereto. The office equipment 818 may include a printer, a projector, a copy machine, etc., but the inventive concept is not limited thereto.

Each of the elements 200, 300, 400, 812, 814, 816, and 818 may be an IoT device.

Each of the IoT devices 200, 300, 400, 812, 814, 816, and 818 may communicate with one another through the hub 500. For example, each of the IoT devices 200, 300, 400, 812, 814, 816, and 818 may transmit or receive detection data or control information with the hub 500.

The IoT devices 200, 300, 400, 812, 814, 816, and 818 may communicate (or be paired) with the hub 500 via a communication network. The home network system 810 may use a sensor network, an M2M network, an internet protocol (IP) based network, or a non-IP based network.

The home network system 810 may be implemented as a home phoneline networking alliance (PNA), IEEE1394, a USB, a programmable logic controller (PLC), Ethernet, infrared data association (IrDA), Bluetooth, Wi-Fi, WLAN, ultra wide band (UWB), ZigBee, wireless 1394, wireless USB, NFC, RFID, or a mobile cellular network.

The IoT devices 200, 300, 400, 812, 814, 816, and 818 may be connected to the communication network 850 through the hub 500 which functions as a home gateway. The hub 500 may convert a protocol between the home network system 810 and the communication network 850. The hub 500 may convert a protocol among various types of communication networks included in the home network system 810 and may connect the IoT devices 200, 300, 400, 812, 814, 816, and 818 with the home server 819.

For example, the home server 819 may be installed at home or in an apartment block. The home server 819 may store or analyze data output from the hub 500. The home server 819 may provide a service relevant to the analyzed information for at least one of the IoT devices 200, 300, 400, 812, 814, 816, and 818 or the user's smart phone 830 or may transmit the analyzed information to the communication network 850 through the hub 500.

The home server 819 may receive and store external contents through the hub 500, may process data, and may provide the processed data for at least one of the IoT devices 200, 300, 400, 812, 814, 816, and 818 or the user's smart phone 830.

For example, the home server 819 may store I/O data transmitted from the security/safety equipment 814 or may provide an automatic security service or power management service for the IoT devices 812, 814, 816, and 818 based on the I/O data.

When each of the IoT devices 812, 814, 816, and 818 includes a sensor for sensing luminance, humidity, or contamination; the home server 819 may analyze data output from each IoT device 812, 814, 816, or 818 including the sensor to generate an analysis result and may provide an environment control service according the analysis result or send the analysis result to the user's smart phone 830.

The communication network 850 may include an internet and/or or a public communication network. The public communication network may include a mobile cellular network. The communication network 850 may be a communication channel which transmits information gathered by the IoT devices 200, 300, 400, 812, 814, 816, and 818 of the home network system 810.

The server 870 may store or analyze the gathered information and may generate service information related with the analysis result or may provide the stored or analyzed information for the service provider 890 and/or the user's smart phone 830.

The service provider 890 may analyze gathered information and may provide various services for a user according to the analysis result. The service provider 890 may provide a service, such as remote meter-reading, crime/disaster prevention, homecare, healthcare, entertainment, education, civil service, etc., for at least one of the IoT devices 200, 300, 400, 812, 814, 816, and 818 or the user's smart phone 830.

For example, the service provider 890 may receive information generated by at least one of the IoT devices 200, 300, 400, 812, 814, 816, and 818 from the server 870 and may provide a service of remotely reading information related with an energy resource (such as gas, water, or electricity) based on the received information. The service provider 890 may receive information generated by at least one of the IoT devices 200, 300, 400, 812, 814, 816, and 818 from the server 870; may generate energy resource-related information, indoor environment information, or user status information based on the received information; and may provide the generated information for at least one of the IoT devices 200, 300, 400, 812, 814, 816, and 818 or the user's smart phone 830.

The service provider 890 may provide an emergency rescue service for crime/disaster prevention based on security-related information, information about a fire outbreak, or safety-related information; or may send the information to the user's smart phone 830. The service provider 890 may also provide entertainment, education, administration service, etc. based on information received from at least one of the IoT devices 200, 300, 400, 812, 814, 816, and 818 and may provide a two-way service through at least one of the IoT devices 200, 300, 400, 812, 814, 816, and 818.

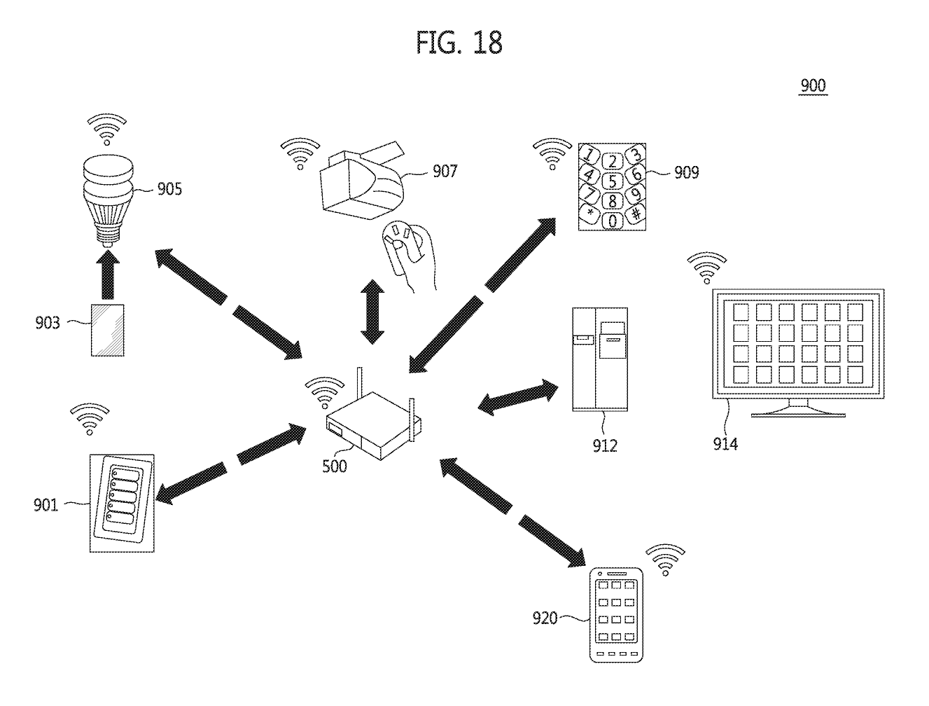

FIG. 18 is a block diagram of a data processing system 900 including the hub 500 illustrated in FIG. 1 according to an exemplary embodiment of the inventive concept.

Referring to FIGS. 1 through 7 and FIG. 18, the IoT network system 900 may be a smart lighting-network system which controls a light emitting device (e.g., a light emitting diode (LED)). For example, the IoT network system 900 may be formed using various kinds of lighting fixtures and wired/wireless communication devices and may include a sensor, a controller, a communication unit, and a software component (e.g., software for network control and user maintenance and so on).

The IoT network system 900 may be used in a closed space defined as an inside of a building, such as a home or an office; and in an open space, such as a park or a street, as well. For example, the IoT network system 900 may be implemented to gather and/or process various kinds of information output from at least one sensor and may provide the information to a user's smart phone 920.

An LED lamp 905 included in the IoT network system 900 may receive information about a surrounding environment from the hub 500 or the user's smart phone 920 and may control its light based on the information. The LED lamp 905 may also check and control the operation state of at least one of IoT devices 901, 903, 907, 909, 912, and 914 included in the IoT network system 900 based on a communication protocol, e.g., a visible light communication protocol, of the LED lamp 905.

The IoT network system 900 may include the hub 500 which performs the function of a gateway processing data transferred according to different communication protocols, the user's smart phone 920 paired with the hub 500, the LED lamp 905 which can communicate with the hub 500 and includes a light emitting element, and the IoT devices 901, 907, 909, 912, and 914 which can communicate with the hub 500 according to various kinds of radio communication methods.

For example, the LED lamp 905 may include a lamp communication module 903, which may function as a communication module.

Each of the IoT devices 901, 907, 909, 912, and 914 may include the light switch 901, the garage door lock 907, the digital door lock 909, the refrigerator 912, and the TV 914.

In the IoT network system 900, the LED lamp 905 may check the operation status of at least one of the IoT devices 901, 907, 909, 912, and 914 using a radio communication network or may automatically adjust its own luminance according to a surrounding environment or circumstance. The LED lamp 905 may also control the operation of at least one of the IoT devices 901, 907, 909, 912, and 914 using LED Wi-Fi (LiFi) using visible rays emitted from the LED lamp 905.

The LED lamp 905 may automatically adjust its own luminance based on surrounding environment information transmitted from the hub 500 or the user's smart phone 920 through the lamp communication module 903 or based on surrounding environment information gathered from a sensor attached to the LED lamp 905.

For example, the brightness of the LED lamp 905 may be automatically adjusted according to the type of a program on the TV 914 or the brightness of the screen of the TV 914. For this operation, the LED lamp 905 may receive operation information of the TV 914 through the lamp communication module 903 wirelessly connected with the hub 500 or the user's smart phone 920. The lamp communication module 903 may be integrated with a sensor included in the LED lamp 905 and/or a controller included in the LED lamp 905 into a module.

When a predetermined period of time elapses after the digital door lock 909 is locked with no one at home, the LED lamp 905 can be turned off according to the control of the hub 500 or the user's smart phone 920. As a result, power waste is reduced. When a security mode is set according to the control of the hub 500 or the user's smart phone 920, the LED lamp 905 is maintained in an on-state even if the digital door lock 909 is locked with no one at home.

An on or off of the LED lamp 905 may be controlled according to surrounding environment information gathered through sensors included in the IoT network system 900. The LED lamp 905 including at least one sensor, a storage device, and the lamp communication module 903 may keep a building secure or may detect an emergency. For example, when the LED lamp 905 includes a sensor for detecting smoke, CO₂, or temperature; the LED lamp 905 may detect fire and output a detection signal through an output unit or send the detection signal to the hub 500 or the user's smart phone 920.

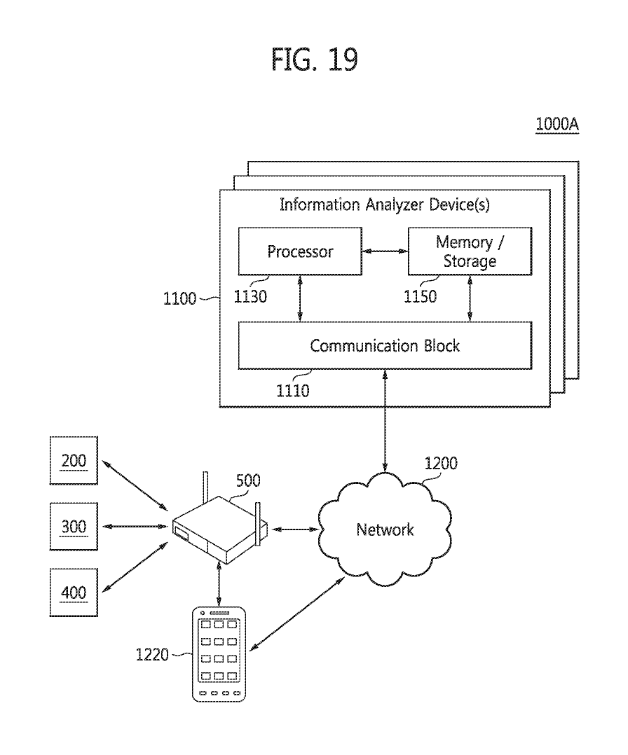

FIG. 19 is a block diagram of a data processing system 1000A including the hub 500 illustrated in FIG. 1 according to an exemplary embodiment of the inventive concept. Referring to FIGS. 1 through 7 and FIG. 19, the IoT network system 1000A may be implemented as a service system providing services for users. The IoT network system 1000A may include the IoT devices 200, 300, and 400, the hub 500, a user's smart phone 1220, a communication network 1200, and an information analyzer device 1100.

The user's smart phone 1220 may be used by a subject who requests at least one service. The user may request a service using the smart phone 1220 and provided with the service.

The information analyzer device 1100 may analyze information to provide a service. The information analyzer device 1100 may analyze information necessary to achieve the goal of the service. The information analyzer device 1100 may include a universal computer like a PC and/or a dedicated computer like a workstation. The information analyzer device 1100 may include at least one computing device. For example, the information analyzer device 1100 may include a communication block 1110, a processor 1130, and a memory/storage 1150.

The communication block 1110 may communicate with the user's smart phone 1220 and/or the hub 500 via the communication network 1200. The communication block 1110 may be provided with information and data through the communication network 1200. The communication block 1110 may transmit the result necessary to provide the service to the user's smart phone 1220 through the communication network 1200. The processor 1130 may receive and process information and data to generate a processing result and outputs the processing result to provide the service. The memory/storage 1150 may store data that has been processed or will be processed by the processor 1130.

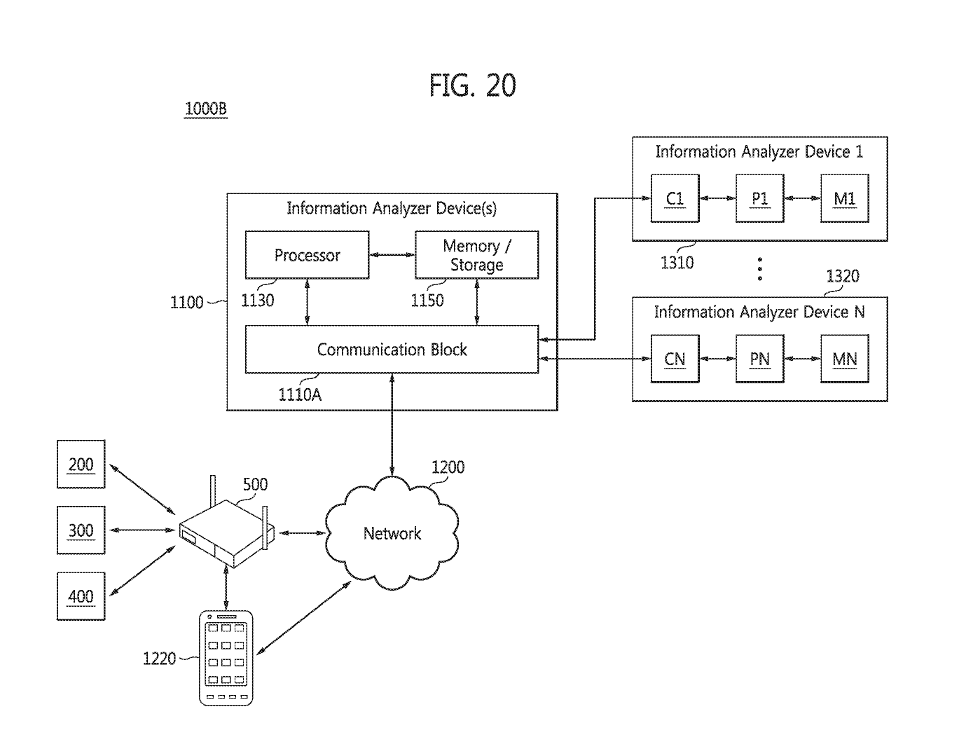

FIG. 20 is a block diagram of a data processing system 1000B including the hub 500 illustrated in FIG. 1 according to an exemplary embodiment of the inventive concept. Referring to FIGS. 1 through 7 and FIG. 20, the IoT network system 1000B may include the IoT devices 200, 300, and 400, the hub 500, the user's smart phone 1220, the communication network 1200, the first information analyzer device 1100, the second information analyzer devices 1310 through 1320. Apart from the second information analyzer devices 1310 through 1320, the IoT network system 1000B illustrated in FIG. 20 is the same as or similar to the IoT network system 1000A illustrated in FIG. 19.

While the IoT network system 1000A illustrated in FIG. 19 includes one information analyzer device 1100, the IoT network system 1000B illustrated in FIG. 20 may also include the second information analyzer devices 1310 through 1320. For example, the information analyzer device 1310 may include a communication block C1, a processor P1, and a memory/storage M1; and the information analyzer device 1320 may include a communication block CN, a processor PN, and a memory/storage MN.

The structure and operations of each of the second information analyzer devices 1310 through 1320 may be the same as or similar to those of the first information analyzer device 1100 illustrated in FIG. 20. Each of the second information analyzer devices 1310 through 1320 may analyze information necessary to provide a service for a user.

The first information analyzer device 1100 may manage the operation of the second information analyzer devices 1310 through 1320. The first information analyzer device 1100 may distribute information or data subjected to analysis to the second information analyzer devices 1310 through 1320. Information necessary to provide a service for a user may be processed in the information analyzer devices 1100 and 1310 through 1320 in a distributed fashion.

The first information analyzer device 1100 may include a communication block 1110A, the processor 1130, and the memory/storage 1150. The first information analyzer device 1100 may communicate with the communication blocks Cl through CN of the respective second information analyzer devices 1310 through 1320 through the communication block 1110A. The first information analyzer device 1100 may also communicate with the other elements 1310 and 1320 through the communication block 1110A. The first information analyzer device 1100 may manage and schedule the information analyzing and/or processing performed by the second information analyzer devices 1310 through 1320 according to the operations of the processor 1130 and the memory/storage 1150.

As described above, according to at least one embodiment of the inventive concept, a semiconductor device processes sensitive data among user data according to a user data management rule set by a user to generate processed data and transmits the processed data to a server, so that the security of the sensitive data is increased and the server is allowed to analyze and use the processed data.

While the inventive concept has been particularly shown and described with reference to exemplary embodiments thereof, it will be understood by those of ordinary skill in the art that various changes in forms and details may be made therein without departing from the spirit and scope of the inventive concept.

What is claimed is:

1. A method of operating a hub which manages user data communicated between a server and a plurality of internet of things (IoT) devices, the method comprising:
storing, by the hub, a user data management rule set by a user;
processing, by the hub, sensitive data among user data transmitted from one of the IoT devices to the hub according to the user data management rule to generate processed data; and
transmitting, by the hub, the processed data to the server.

2. The method of claim 1, further comprising storing the sensitive data that has not been processed in a memory of the hub.

3. The method of claim 1, wherein the storing the user data management rule comprises:
storing a basic data management rule;
displaying the basic data management rule for the user to enable the user to request a change to the basic data management rule; and
storing a changed data management rule according to the change request.

4. The method of claim 1, further comprising:
authenticating the user using user authentication information; and
allowing the user data management rule to be set, changed, or cancelled when the authenticating of the user is successful.

5. The method of claim 1, wherein the data management rule comprises at least one among a type of the sensitive data and a security level of the sensitive data.

6. The method of claim 5, wherein when the security level of the user data increases, a proportion of a part hidden to be undistinguishable in the sensitive data increases.

7. The method of claim 1, wherein the processing comprises one of encrypting all of the sensitive data so that all the sensitive data is undistinguishable in the server and performing a blurring process on part of the sensitive data so that part of the sensitive data is undistinguishable in the server.

8. The method of claim 1, wherein the processing includes computing trend information by performing an arithmetic operation on at least two data sets in the sensitive data, by selecting one of the at least two data sets, or by comparing the at least two data sets.

9. The method of claim 1, wherein the sensitive data comprises biometric data.

10. The method of claim 1, wherein the transmitting the processed data to the server comprises transmitting the processed data to the server periodically or non-periodically according to data scheduling of the hub.

11. A semiconductor device for managing user data communicated between a server and a plurality of internet of things (IoT) devices, the semiconductor device comprising:
a first communication module configured to receive user data from one of the IoT devices;
a data balancing module configured to process sensitive data among the user data according to a user data management rule set by a user to generate processed data; and
a second communication module configured to transmit the processed data from the data balancing module to the server,
wherein the semiconductor device enables the user data management rule to be set or changed by the user.

12. The semiconductor device of claim 11, further comprising a memory configured to store the sensitive data that has not been processed.

13. The semiconductor device of claim 12, wherein the data balancing module generates the processed data by processing a part or all of the sensitive data to be undistinguishable.

14. The semiconductor device of claim 12, wherein the data balancing module computes trend information by performing an arithmetic operation on at least two data sets of the sensitive data, selecting the at least two data sets, or comparing the at least two data sets with each other and outputs the trend information as the processed data.

15. The semiconductor device of claim 11, further comprising a processor configured to authenticate the user using authentication information of the user and to allow the user data management rule to be changed or cancelled when the authentication of the user is successful.

16. The semiconductor device of claim 11, wherein the semiconductor device is a hub.

17. A semiconductor device for managing user data communicated between a server and a plurality of internet of things (IoT) devices, the semiconductor device comprising:
a transceiver configured to receive the user data from one of the IoT devices and transmit processed data to the server; and
a data processing circuit configured to perform a selected one of an encryption of all sensitive data among the user data or a blurring of part of the sensitive data to generate the processed data.

18. The semiconductor device of claim 17, wherein the semiconductor device provides a user interface that enables a user to increase a security level to select the encryption and decrease the security level to select the blurring.

19. The semiconductor device of claim 17, wherein the semiconductor device selects one of the encrypting and blurring according to a user data management rule stored within the device.

20. The semiconductor device of claim 19, wherein the semiconductor device is configured to authenticate a user associated with the user data using user authentication information stored within the semiconductor device, and enables the user data management rule to be changed by the user when the authentication is successful.
